(19) United States
(12) Patent Application Publication
(10) Pub. No.: US 2014/0032414 A1
(43) Pub. Date: Jan. 30, 2014

(54) ACCOUNT-TO-ACCOUNT TRANSFERS

(71) Applicant: Accullink, Inc., Atlanta, GA (US)

(72) Inventors: JOHN BEISNER, ALPHARETTA, GA (US); NANDAN S. SHETH, ATLANTA, GA (US)

(73) Assignee: ACCULLINK, INC., ATLANTA, GA (US)

(21) Appl. No.: 13/951,713

(22) Filed: Jul. 26, 2013

Related U.S. Application Data
(60) Provisional application No. 61/676,198, filed on Jul. 26, 2012.

(51) Int. Cl. G06Q 20/38

(52) U.S. Cl. CPC G06Q 20/382
USPC 705/44

(57) ABSTRACT

Computer program products, methods, systems, apparatus, and computing entities are provided for transferring funds. In one embodiment, a sender can provide account information and be authenticated to transfer funds to a receiver. The funds can then be transferred to the receiver or held in escrow for transfer to the receiver upon receipt of the receiver's account information.

### CROSS-REFERENCE TO RELATED APPLICATIONS

This application claims priority to U.S. Provisional Application No. 61/676,198 filed Jul. 26, 2012, which is hereby incorporated herein in its entirety by reference.

### BACKGROUND

With the explosion of ecommerce and electronic funds transfers, a need exists to provide for account-to-account transfers. In a particular example, a need exists for providing authenticated account-to-account transfers that occur in real time.

### BRIEF SUMMARY

In general, embodiments of the present invention provide methods, apparatus, systems, computing devices, computing entities, and/or the like for transferring funds.

In accordance with one aspect, a method for transferring funds is provided. In one embodiment, the method comprises (1) receiving a request to transfer good funds from a sender account to a receiver, the request to transfer good funds (a) originating from a user of the sender account, (b) identifying at least a portion of debit card number associated with the sender account, (c) identifying the receiver, (d) identifying an amount of good funds to transfer, and (d) to occur in real time through a payment network; (2) authenticating the request to transfer good funds from the sender account by receiving one or more authentication inputs from the user of the sender account; and (3) responsive to authenticating the request to transfer good funds from the sender account, initiating the transfer of good funds from the sender account through the payment network, wherein the good funds are transmitted in real time through the payment network responsive to the initiation.

In accordance with another aspect, a computer program product for transferring funds is provided. The computer program product may comprise at least one computer-readable storage medium having computer-readable program code portions stored therein, the computer-readable program code portions comprising executable portions configured to (1) receive a request to transfer good funds from a sender account to a receiver, the request to transfer good funds (a) originating from a user of the sender account, (b) identifying at least a portion of debit card number associated with the sender account, (c) identifying the receiver, (d) identifying an amount of good funds to transfer, and (d) to occur in real time through a payment network; (2) authenticate the request to transfer good funds from the sender account by receiving one or more authentication inputs from the user of the sender account; and (3) responsive to authenticating the request to transfer good funds from the sender account, initiate the transfer of good funds from the sender account through the payment network, wherein the good funds are transmitted in real time through the payment network responsive to the initiation.

In accordance with yet another aspect, an apparatus comprising at least one processor and at least one memory including computer program code is provided. In one embodiment, the at least one memory and the computer program code may be configured to, with the processor, cause the apparatus to (1) receive a request to transfer good funds from a sender account to a receiver, the request to transfer good funds (a) originating from a user of the sender account, (b) identifying at least a portion of debit card number associated with the sender account, (c) identifying the receiver, (d) identifying an amount of good funds to transfer, and (d) to occur in real time through a payment network; (2) authenticate the request to transfer good funds from the sender account by receiving one or more authentication inputs from the user of the sender account; and (3) responsive to authenticating the request to transfer good funds from the sender account, initiate the transfer of good funds from the sender account through the payment network, wherein the good funds are transmitted in real time through the payment network responsive to the initiation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of an account-to-account server according to one embodiment of the present invention.

FIG. 3 is an exemplary schematic diagram of a sender or receiver computing entity according to one embodiment of the present invention.

FIG. 4 is a block diagram illustrating the linkage of the account-to-account server to one or more senders through a communications network.

FIG. 5 is a block diagram illustrating the linkage of the account-to-account server to one or more payment networks, including one or more of the following.

FIG. 6 is a block diagram illustrating the linkage of the account-to-account server to email communication, social networks, and other programmatic mechanisms through a communications network.

FIG. 7 is a block diagram illustrating the linkage of the account-to-account server to receivers/recipients.

FIG. 8 is a flowchart illustrating operations and processes that can be used in accordance with various embodiments of the present invention.

FIGS. 9-10 are exemplary input and output that can be produced in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

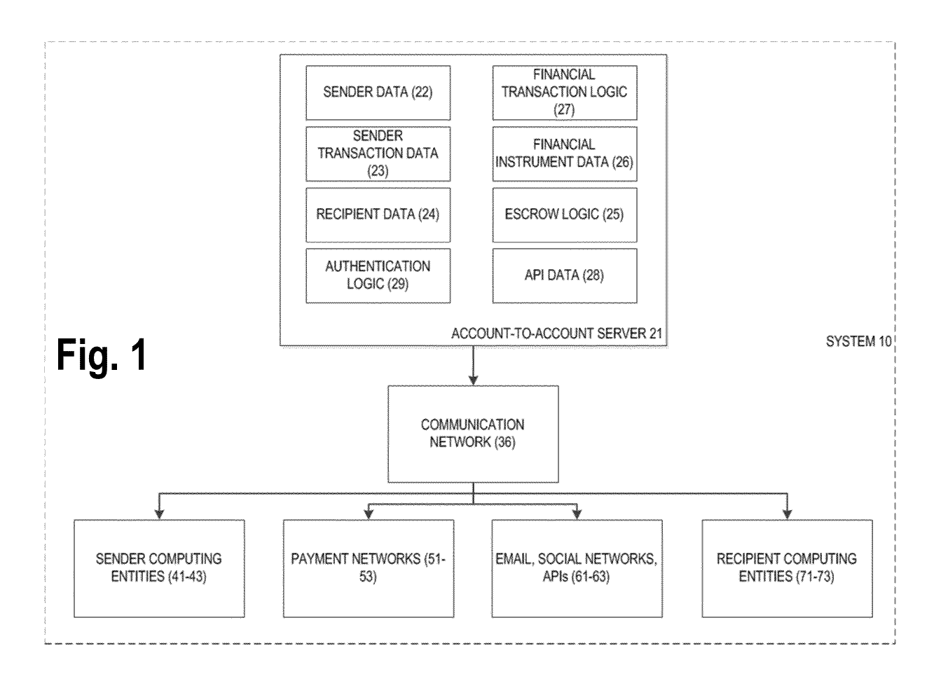

FIG. 1 provides an illustration of an exemplary embodiment of the present invention. As shown in FIG. 1, the system 10 of this particular embodiment may include one or more account-to-account servers 21; one or more communication networks 36; one or more sender computing entities 41-43; one or more payment networks 51-53; one or more email, social, or programmatic mechanisms 61-63; and one or more receiver/recipient computing entities 71-73. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Account-to-Account Server

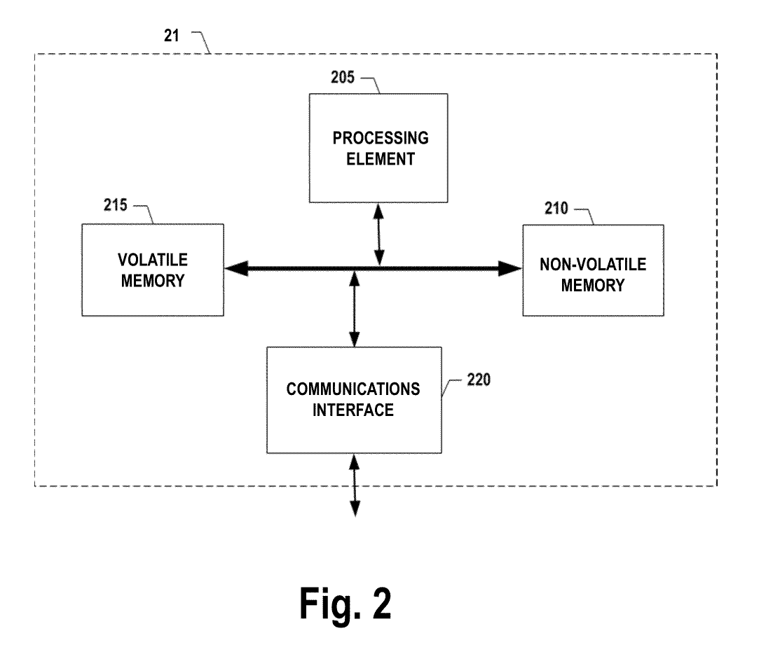

FIG. 2 provides a schematic of an account-to-account server 21 according to one embodiment of the present invention. As will be recognized by one of ordinary skill in the art, an account-to-account server 21 may include the following as described herein (whether software, hardware, firmware, or any combination thereof). The account-to-account server 21 can be operated separately by a third-party entity, such as Acculynk, and/or integrated into one or more systems of a financial institution or ecommerce website, for example, to provide the appearance of being part of the financial institution or ecommerce website. In general, the terms computing entity, entity, device, system, and/or similar words used herein interchangeably may refer to, for example, one or more computers, computing entities, computing devices, mobile phones, gaming consoles, desktops, tablets, notebooks, laptops, distributed systems, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably (e.g., sender data 22, sender transaction data 23, receiver/recipient data 24, financial instrument data 26, and application programming interface (API) data 28. As indicated, in one embodiment, the account-to-account server 21 may also include one or more communications interfaces 220 for communicating with various computing entities, such as by communicating data, content, information, and/or similar terms used herein interchangeably that can be transmitted, received, operated on, processed, displayed, stored, and/or the like. For instance, the account-to-account server 21 may communicate with one or more communication networks 36; one or more sender computing entities 41-43; one or more payment networks 51-53; one or more email, social, or programmatic mechanisms 61-63; and one or more receiver/recipient computing entities 71-73.

As shown in FIG. 2, in one embodiment, the account-to-account server 21 may include or be in communication with one or more processing elements 205 (also referred to as processors, processing circuitry, and/or similar terms used herein interchangeably) that communicate with other elements within the account-to-account server 21 via a bus, for example. As will be understood, the processing element 205 may be embodied in a number of different ways. For example, the processing element 205 may be embodied as one or more complex programmable logic devices (CPLDs), microprocessors, multi-core processors, coproces sing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the account-to-account server 21 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like (e.g., escrow logic 25, financial transaction logic 27, authentication logic 29, and/or the like). The terms database, database instance, database management system, and/or similar terms used herein interchangeably may refer to a structured collection of records or data that is stored in a computer-readable storage medium, such as via a relational database, hierarchical database, and/or network database.

In one embodiment, the account-to-account server 21 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Through such code, the account-to-account server 21 can manage the secure transfer of funds from a sender to a receiver/recipient or into an escrow account and then to a receiver or recipient. Thus, the databases, database instances, database management systems, data, applications, programs, program modules, scripts, source code, object code, byte code, compiled code, interpreted code, machine code, executable instructions, and/or the like may be used to control certain aspects of the operation of the account-to-account server 21 with the assistance of the processing element 205 and operating system.

As indicated, in one embodiment, the account-to-account server 21 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the account-to-account server 21 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Although not shown, the account-to-account server 21 may include or be in communication with one or more input elements, such as a keyboard input, a mouse input, a touch screen/display input, audio input, pointing device input, joystick input, keypad input, and/or the like. The account-to-account server 21 may also include or be in communication with one or more output elements (not shown), such as audio output, video output, screen/display output, motion output, movement output, and/or the like.

As will be appreciated, one or more of the account-to-account server's 21 components may be located remotely from other account-to-account server 21 components, such as in a distributed system. Furthermore, one or more of the components may be combined and additional components performing functions described herein may be included in the account-to-account server 21. Thus, the account-to-account server 21 can be adapted to accommodate a variety of needs and circumstances.

### 2. Exemplary Sender Computing Entity

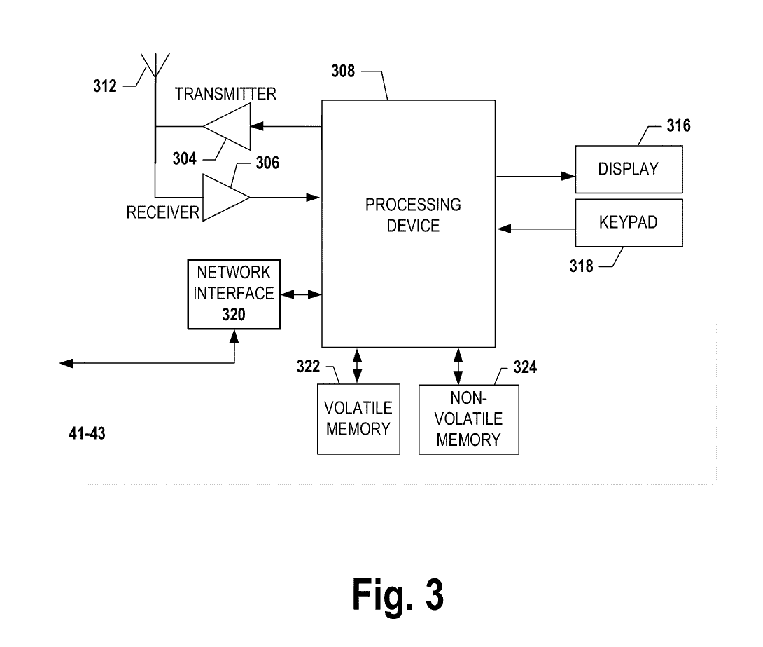

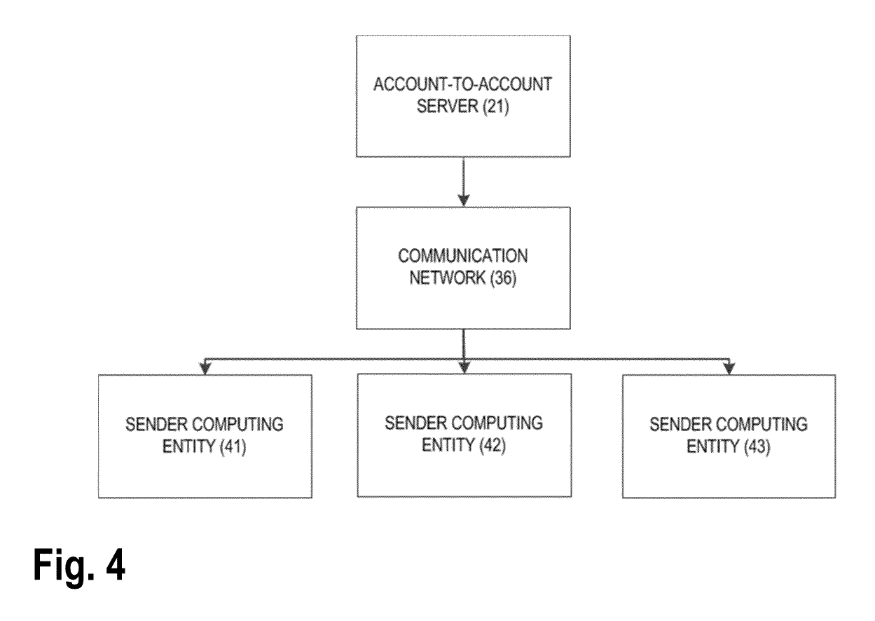

In one embodiment, a sender (user) may be any individual, group of individuals, family, company, organization, entity, department within an organization, representative of an organization and/or person, and/or the like. FIG. 3 provides an illustrative schematic representative of a sender computing entity 41-43 that can be used in conjunction with embodiments of the present invention (see also FIG. 4). As will be recognized by one of ordinary skill in the art, a sender computing entity 41-43 may include the following as described herein (whether software, hardware, firmware, or any combination thereof). The terms sender and sender computing entity are used throughout interchangeably. In general, the terms device, system, computing entity, entity, and/or similar words used herein interchangeably may refer to, for example, one or more computers, computing devices, computing entities, mobile phones, desktops, tablets, notebooks, laptops, distributed systems, watches, glasses, key fobs, RFID tags, ear pieces, scanners, cameras, wristbands, kiosks, input terminals, servers or server networks, blades, gateways, switches, processing devices, processing entities, relays, routers, network access points, base stations, the like, and/or any combination of devices or entities adapted to perform the functions, operations, and/or processes described herein. Sender computing entities 41-43 can be operated by various parties. As shown in FIG. 3, the sender computing entity 41-43 can include an antenna 312, a transmitter 304 (e.g., radio), a receiver 306 (e.g., radio), and a processing element 308 (such as those described above with regard to the account-to-account server 21) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the sender computing entity 41-43 may be capable of operating with one or more air interface standards, communication protocols, modulation types, and access types. More particularly, the sender computing entity 41-43 may operate in accordance with any of a number of wireless communication standards and protocols, such as those described above with regard to the account-to-account server 21. In a particular embodiment, the sender computing entity 41-43 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, WiMAX, UWB, IR, Bluetooth, USB, and/or the like. Similarly, the sender computing entity 41-43 may operate in accordance with multiple wired communication standards and protocols, such as those described above with regard to the account-to-account server 21 via a network interface 320.

Via these communication standards and protocols, the sender computing entity 41-43 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The sender computing entity 41-43 can also download changes, add-ons, and updates, for instance, to its firmware, software (e.g., including executable instructions, applications, program modules), and operating system.

According to one embodiment, the sender computing entity 41-43 may include a location determining device and/or functionality. For example, the sender computing entity 41-43 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The sender computing entity 41-43 may also comprise a sender/user interface (that can include a display 316 coupled to a processing element 308) and/or a user input interface (coupled to a processing element 308). For example, the sender/user interface may be an appropriate application, browser, dashboard, sender/user interface, and/or similar words used herein interchangeably executing on and/or accessible via the sender computing entity 41-43 to interact with and/or cause display of information from the account-to-account server 21, as described herein. The user input interface can comprise any of a number of devices allowing the sender computing entity 41-43 to receive data, such as a keypad 318 (hard or soft), a touch display, voice or motion interfaces, or other input device. In embodiments including a keypad 318, the keypad 318 can include (or cause display of) the conventional numeric (0-9) and related keys (#, *), and other keys used for operating the sender computing entity 41-43 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The sender computing entity 41-43 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the sender computing entity 41-43. As indicated, this may include a sender application that is resident on the entity or accessible through a browser or other sender/user interface for communicating with the account-to-account server 21, receiver/recipient computing entity 71-73, and/or various other computing entities.

In another embodiment, the sender computing entity 41-43 may include one or more components that are functionally similar to those of the account-to-account server 21, as described in greater detail above.

### 3. Exemplary Receiver/Recipient Computing Entity

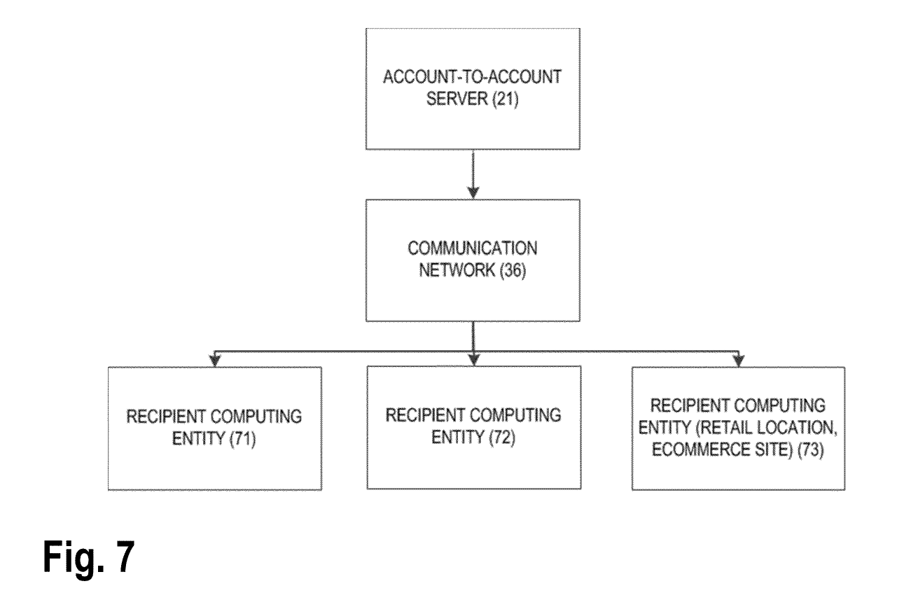

In one embodiment, a receiver/recipient (user) may be an individual, a family, a company, an organization, an entity, a department within an organization (e.g., retailer, ecommerce website, biller, merchant, and/or the like), a representative of an organization and/or person (e.g., representative of a recipient), and/or the like (see FIG. 7). In one embodiment, a receiver/recipient may operate a receiver/recipient computing entity 71-73 that includes one or more components that are functionally similar to those of the account-to-account server 21 and/or the sender computing entity 41-43. As will be recognized by one of ordinary skill in the art, a receiver/recipient computing entity 71-73 may include the following as described herein (whether software, hardware, firmware, or any combination thereof). For example, in one embodiment, each receiver/recipient computing entity 71-73 may include one or more processing elements, one or more display device/input devices (e.g., including receiver/recipient/user interfaces), volatile and non-volatile storage or memory, and/or one or more communications interfaces. For example, the receiver/recipient/user interface may be an appropriate application, browser, dashboard, receiver/recipient/user interface, and/or similar words used herein interchangeably executing on and/or accessible via the receiver/recipient computing entity 71-73 to interact with and/or cause display of information from the account-to-account server 21, as described herein. This may also enable to the receiver/recipient computing entity 71-73 to communicate with various other computing entities, such as sender computing entities 41-43, payment networks/systems 51-53, and/or various other computing entities.

These architectures are provided for exemplary purposes only and are not limiting to the various embodiments. The term computing entity may refer to one or more computers, computing entities, mobile phones, desktops, tablets, notebooks, laptops, distributed systems, watches, glasses, key fobs, RFID tags, ear pieces, scanners, cameras, wristbands, kiosks, input terminals, servers, blades, gateways, switches, processing devices, processing entities, relays, routers, network access points, base stations, the like, and/or any combination of devices or entities adapted to perform the functions, operations, and/or processes described herein.

### 4. Exemplary Payment Network/System

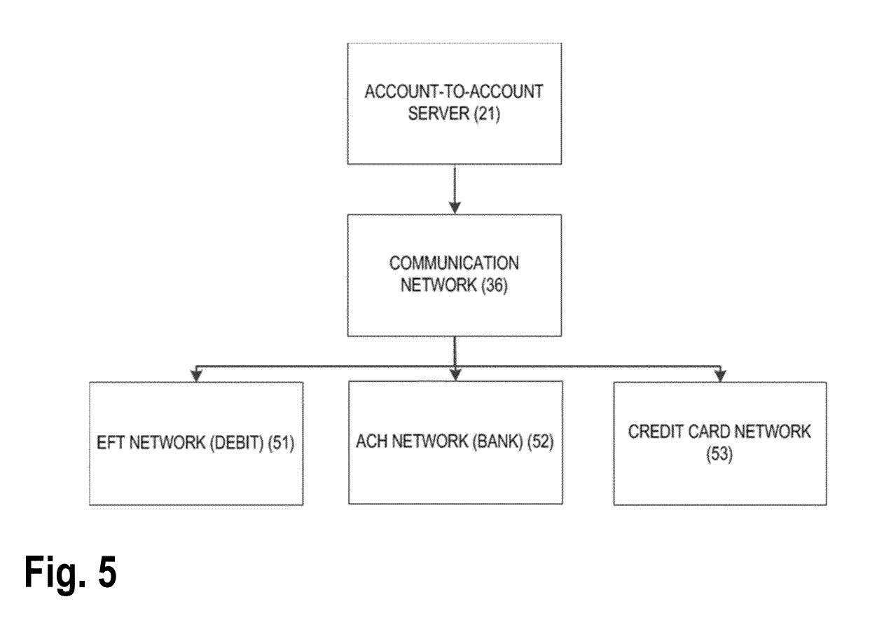

A payment network/system 51-53 may be any network/system through which electronic payments or fund transfers can occur. In one embodiment, such payment networks/systems 51-53 may include debit card, credit card, direct credits, direct debits, Internet banking, and e-commerce payment networks/systems, and/or the like. For example, FIG. 5 depicts the connection of the account-to-account server 21 with electronic funds transfer (EFT) (debit) networks/systems 51, automated clearing house (ACH) (bank) networks/systems 52, and credit card networks/systems 53. For illustrative purposes, three methods of payment 51-53 are shown, but any number of existing or new payment or redemption types 51-53 may be used. As will be recognized by one of ordinary skill in the art, payment networks/systems 51-53 may include the following as described herein (whether software, hardware, firmware, or any combination thereof). For example, in one embodiment, such payment networks/systems may include one or more components that are functionally similar to those of the account-to-account server 21, the sender computing entities 41-43, the receiver computing entities 71-73, and/or the like.

### 5. Exemplary External Accounts

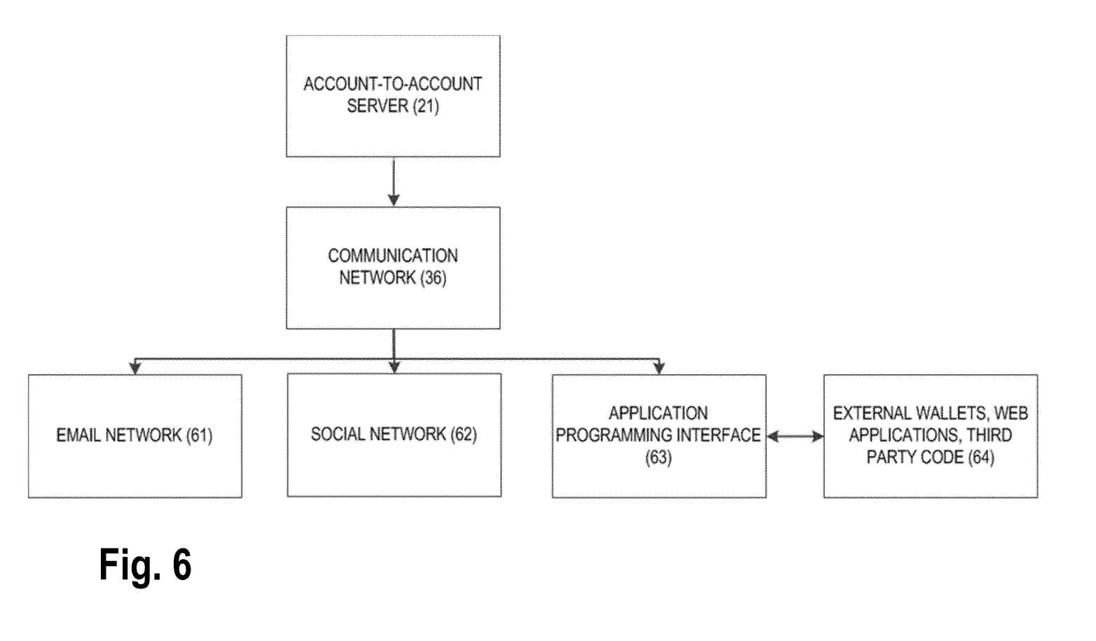

In one embodiment, the account-to-account server 21 may include or be associated or in communication with various external accounts, interfaces, and entities 61-63. Such external accounts, interfaces, and entities 61-63 may include email accounts/services 61, social networks/services 62 (e.g., Facebook, Twitter, Foursquare, Google+), APIs 63, and/or the like (see FIG. 6). These external accounts, interfaces, and entities 61-63 may be associated with senders 51-53 or receivers/recipients 71-73. In one embodiment, the account-to-account server can pull/receive and/or push/provide data associated with senders 51-53 and receivers/recipients 71-73 through such external accounts, interfaces, and entities. As will be recognized by one of ordinary skill in the art, such external accounts, interfaces, and entities may include the following as described herein (whether software, hardware, firmware, or any combination thereof). For example, in one embodiment, such external accounts, interfaces, and entities may include one or more components that are functionally similar to those of the account-to-account server 21, the sender computing entities 41-43, payment networks/systems 51-53, the receiver computing entities 71-73, and/or the like. As will be recognized, a variety of approaches and techniques can be used to adapt to various needs and circumstances.

### III. EXEMPLARY SYSTEM OPERATION

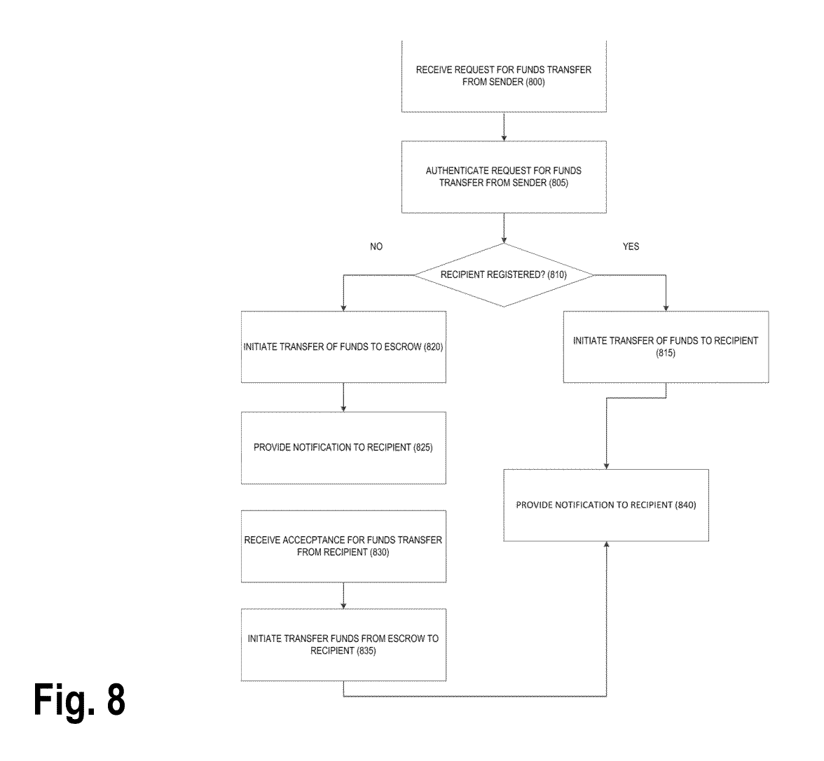

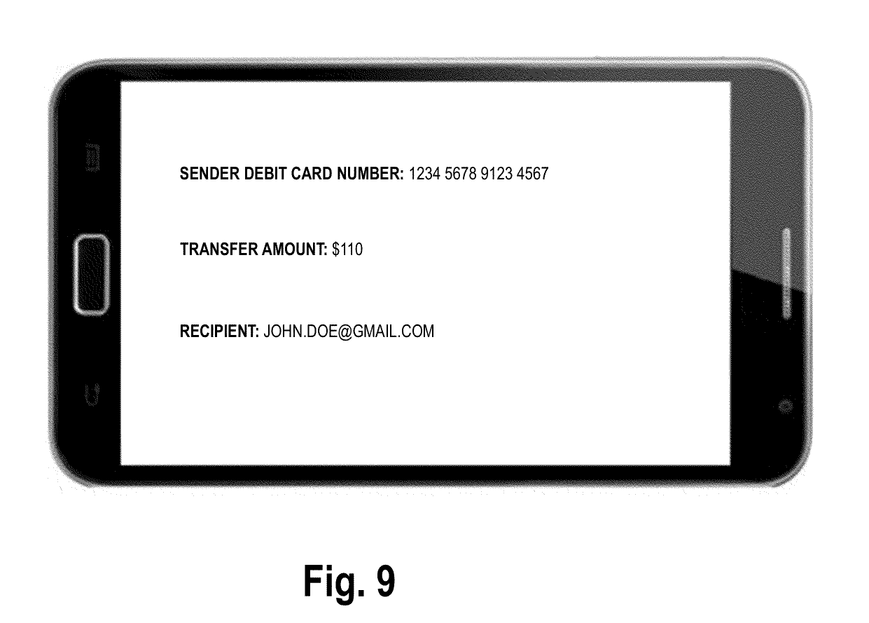

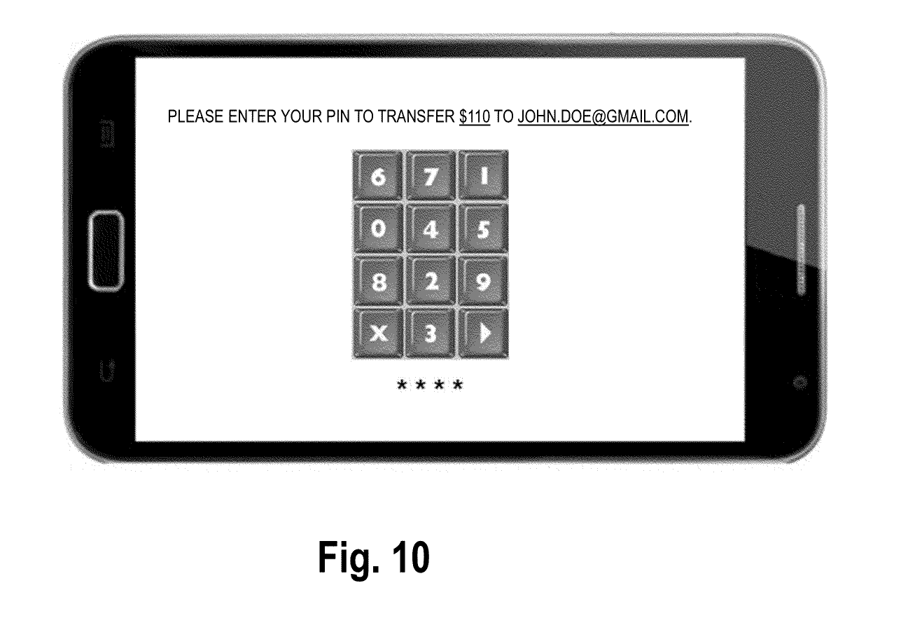

Reference will now be made to FIG. 8-10. FIG. 8 is a flowchart illustrating operations and processes that may be performed for transferring funds. FIGS. 9-10 are exemplary input and output that can be produced in accordance with various embodiments of the present invention.

In certain embodiments, the process may begin by a sender (e.g., operating a sender computing entity 41-43 through an appropriate application, browser, dashboard, or interface) providing sender data 22 to the account-to-account server 21 (in communication with various entities, systems, and networks). The sender data 22 may include information about the sender. As noted, the sender (user) may be any individual, group of individuals, family, company, organization, entity, department within an organization, representative of an organization and/or person, and/or the like. Thus, the sender data 22 may include sender information, such as the sender's name, username, account numbers, routing numbers, physical addresses, email addresses, passwords, personal identification numbers (PINs), phone numbers, account administrators, social network sites, external account names and passwords 61-63, and/or the like. The sender data 22 may also comprise financial instrument data 26, such as information about credit cards, debit cards, bank accounts, financial accounts, and/or the like. The financial instrument data 26 can be used to remit funds to receivers/recipients. As will be recognized, a variety of financial instruments can be used with embodiments of the present invention. As will be recognized, sender/user 41-43 registration is not necessary to practice embodiments of the present invention. However, registration may enable the sender (e.g., operating a sender computing entity 41-43) to use, manage, and update the sender data 22 stored by the account-to-account server 21. Once the sender data 22 is received by the account-to-account server 21, the account-to-account server 21 can store the sender data 22 in association with a sender profile and/or account. As will be recognized, a variety of other approaches and techniques can be used to adapt to various needs and circumstances.

Similarly, a receiver/recipient (e.g., operating receiver/recipient computing entity 71-73) may provide receiver/recipient data 24 to the account-to-account server 21. As noted, the receiver/recipient (user) 71-73 may be an individual, a family, a company, an organization, an entity, a department within an organization (e.g., retailer, ecommerce website, and/or the like), a representative of an organization and/or person (e.g., representative of a recipient), and/or the like. Accordingly, the receiver/recipient data 24 may include receiver/recipient information, such as the receiver's/recipient's name, username, account numbers, routing numbers, physical addresses, email addresses, passwords, phone numbers, account administrators, social network sites, external account names and passwords 61-63, and/or the like. The receiver/recipient data 24 may also comprise financial instrument data 26, such as information about credit cards, debit cards, banks, financial accounts, and/or the like. The financial instrument data 26 can be used to receive funds from senders. As will be recognized, a variety of financial instruments can be used with embodiments of the present invention. As will be recognized, receiver/recipient registration is not necessary to practice embodiments of the present invention. However, registration may enable the receiver/recipient to use, manage, and update the receiver/recipient data 24 stored by the account-to-account server 21. Once the receiver/recipient data 24 is received by the account-to-account server 21, the account-to-account server 21 can store the receiver/recipient data 24 in association with a receiver/recipient profile and/or account.

In one embodiment, in association with the respective accounts, the account-to-account server 21 may store interactions or financial transactions between various receivers/recipients and senders. As will be recognized, a variety of other approaches and techniques can be used to adapt to various needs and circumstances.

In one embodiment, a sender (e.g., operating a sender computing entity 41-43 through an appropriate application, browser, dashboard, or interface) can request to transfer funds (e.g., a good funds transfer) from the sender's account to a receiver/recipient (Block 800 of FIG. 8). As noted, this can occur whether or not the sender is registered with the account-to-account server 21. The term good funds may refer to funds that are immediately available for transfer from one account to another. In one embodiment, either before or as part of the request, a variety of anti-fraud and anti-phishing techniques and approaches can be used, such as allowing senders to authenticate the account-to-account server 21 using images and text messages and/or using anti-phishing technologies. The request to transfer funds may be a transfer of money from one account to another, either within a single financial institution or across multiple institutions.

In one embodiment, the request may identify the receiver/recipient (e.g., sender transaction data). To identify the receiver/recipient of the funds to be transferred, the sender (e.g., operating a sender computing entity 41-43 through an appropriate application, browser, dashboard, or interface) may input some form of identifying information of the receiver/recipient. For receivers/recipients registered with the account-to-account server 21 and/or with whom the sender has transacted previously, the sender may be able to select profiles or account information corresponding to the receivers/recipients via the appropriate interface. For receivers/recipients not registered with the account-to-account server 21 and/or with whom the sender has not transacted previously, the sender may be able to provide information identifying the receivers/recipients. Such identifying information may include email addresses, social network usernames, phone numbers, account numbers, account-to-account usernames, and/or the like. As will be recognized, a variety of other approaches and techniques can be used to identify receivers/recipients.

In one embodiment, the request to transfer funds (e.g., good funds) may identify an amount to be transferred and an account from which the funds should be transferred. For example, if the sender is registered with the account-to-account server 21, the sender may be able to select a financial instrument from the financial instrument data 26 to use for the financial transaction, such as a debit card (e.g., primary account number (PAN)). If not registered, the sender may input the financial instrument data 26 via the appropriate application, browser, dashboard, or interface, such as a debit card number (e.g., PAN). FIG. 9 illustrates an example of an interface in which a sender has input a request to transfer $110 to John Doe (john.doe@gmail.com) from his debit card (1234 5678 9123 4567). As previously noted, although the example of using a debit card through an EFT network/system is described herein, embodiments of the present invention can be used for wire transfers, cardholder-initiated transactions, bank transactions, direct deposit payments, credit card transactions, direct debit transactions, electronic bill payment in online banking, transactions involving stored value of electronic money, electronic benefit transfer (EBT), and/or the like via various payment systems/network 61-63.

In one embodiment, after receiving the appropriate sender transaction data associated with the funds transfer (e.g., sender account, amount, and receiver/recipient), the account-to-account server 21 can determine whether the specified instrument is capable of authentication as indicated in Block 805 of FIG. 8 (e.g., via authentication logic 29 and API data 28 and/or APIs 63). For instance, the account-to-account server 21 may use the debit card number provided by the sender to determine whether the debit card provided is actually a debit card or a valid debit card. In one embodiment, this may involve communicating with an appropriate payment network/system 51-53 (e.g., EFT network/system). The account-to-account server 21 may also use the sender transaction data 23 to assess the amount/value of the fund transfer with the financial instrument (e.g., based on the financial instrument data 26). As will be recognized, this may occur at later steps as well, such as during the authentication of the sender.

In one embodiment, the sender can be authenticated, verified, validated, and similar words used herein interchangeably. For example, in one embodiment, the account-to-account server 21 (e.g., via authentication logic 29) may provide the sender (e.g., operating a sender computing entity 41-43 through an appropriate application, browser, dashboard, or interface) with a PIN pad to enter his or her PIN associated with the debit card, for example. In another embodiment, the account-to-account server 21 (e.g., via authentication logic 29) may provide the sender (e.g., operating a sender computing entity 41-43) with the appropriate window, modal dialog, input mechanism, interface, and/or the like through which the user can provide various types of authenticating information. Such authenticating information may include biometric information, chip authentication, secure identification (e.g., RSA key fob), and/or the like. FIG. 10 illustrates an interface in which a sender (e.g., operating a sender computing entity 41-43 through an appropriate application, browser, dashboard, or interface) has input his PIN for authentication to transfer funds from his debit card to John Doe.

In one embodiment, after receiving the authentication information as input from the sender (e.g., operating a sender computing entity 41-43 through an appropriate application, browser, dashboard, or interface), the account-to-account server 21 (e.g., via authentication logic 29 and API data 28 and/or APIs 63) can validate, verify, or authenticate the authentication information. As will be recognized, in certain embodiments, this step may involve the account-to-account server 21 communicating with a payment network/system 51-53 (e.g., EFT network/system). Continuing with the above example, the account-to-account server 21 (e.g., via authentication logic 29) may identify the appropriate payment network/system 51-53 (e.g., EFT network/system) for the sender's debit card and determine whether the provided PIN is a valid PIN for the debit card number. The account-to-account server 21 may also use the sender transaction data 23 to assess the amount/value of the fund transfer with the financial instrument (e.g., based on the financial instrument data 26). As will be recognized, this may occur at earlier steps as well. As will be recognized, a variety of other approaches and techniques can be used to adapt to various needs and circumstances.

In one embodiment, if the user is properly authenticated and there are sufficient funds for the transfer, the account-to-account server 21 can provide a receipt or confirmation page to the sender. In another embodiment, the account-to-account server 21 may also send a similar approval notification to the sender's email address or phone number. Continuing with the above example, if the PIN provided by the sender is validated by the account-to-account server 21, the account-to-account server 21 can provide the appropriate receipt, notification, confirmation, and/or similar words used herein interchangeably for display to the sender.

As indicated in Block 810 of FIG. 8, before, after, or simultaneous to the sender being been validated, verified, or authenticated, the account-to-account server 21 can determine whether the receiver/recipient is registered with the account-to-account server 21. For instance, the account-to-account server 21 can make this determination based on the sender transaction data 23 provided by the sender and/or the receiver/recipient data 24 stored by the account-to-account server 21. Further, such a determination may also be made based on previous financial instrument data 26 from previous interactions with the sender and receiver/recipient. If registered, the receiver/recipient may set default accounts or other account preferences to indicate to which accounts funds should be transferred. In one embodiment, if the receiver/recipient is registered with the account-to-account server 21, the account-to-account server 21 (e.g., via the financial transaction logic 27 and API data 28 and/or APIs 63) can initiate the transfer of the specified funds to the designated account of the receiver/recipient—Block 815 of FIG. 8. In the example of the sender and receiver/recipient using debit cards, the account-to-account server 21 (e.g., via the financial transaction logic 27 and API data 28 and/or APIs 63) can initiate transfer of the specified good funds to the designated account of the receiver/recipient via the appropriate payment network/system 51-53 (e.g., EFT network/system), which can then complete the transfer of funds to the receiver's/recipient's account. In the example of the sender and receiver/recipient using debit cards, the transfer of good funds can be carried about by the appropriate EFT payment network/system 51-53 in real time through the EFT payment network/system 51-53—as opposed to submitting the transfer for eventual processing and transfer of funds through an automated clearing house (ACH) that may take 24-48 to complete the transaction. The ACH approach, for example, would not provide for a good funds transfer from one account to another in real time as would the above example. In other embodiments, however, transferring the funds through the delayed approach may be acceptable or desirable.

In one embodiment, after the transfer of funds is complete, the account-to-account server 21 can provide a notification to the receiver/recipient and/or sender that the transfer of funds is complete (Block 840 of FIG. 8). Such notifications may take many forms, such as email messages (e.g., via the email network 61), text messages, automated voice messages, Facebook messages or Tweets (e.g., via the social network 62), notifications via designated interface or application (e.g., via API data 28 and/or APIs 63), and/or the like. As will be recognized, a variety of approaches and techniques can be used to provide the appropriate notifications.

In an embodiment in which the receiver/recipient is not registered with the account-to-account server 21 or in which an account number was not provided as part of the sender transaction data 23, the account-to-account server 21 (e.g., via the escrow logic 25 and API data 28 and/or APIs 63) can initiate transfer of the funds to an escrow account to be held for the receiver/recipient—Block 820 of FIG. 8. In the example of the sender using a debit card, the account-to-account server 21 (e.g., via the escrow logic 25 and API data 28 and/or APIs 63) can initiate transfer of the specified funds to a designated escrow account via the appropriate payment network/system 51-53. As previously described, the transfer of funds can be carried about by the appropriate EFT payment network/system 51-53 to the escrow account in real time through the EFT payment network/system 51-53—as opposed to submitting the transfer for eventual processing and transfer of funds through an ACH that may take 24-48 to complete the transaction. As will be recognized, the escrow account may be owned, operated, or maintained by various entities, including a financial institution associated with the sender. In one embodiment, the funds may be held in escrow up to a prescribed period of time. After the expiration of the period of time, the account-to-account server 21 (e.g., via the escrow logic 25 and API data 28 and/or APIs 63) can return the funds to the sender's account if not accepted from the escrow by the receiver/recipient.

As part of the transaction, the account-to-account server 21 can provide a notification to the receiver/recipient that a sender is transferring funds to the receiver/recipient (Block 825 of FIG. 8). Such notifications may take many forms, such as email messages (e.g., via the email network 61 and API data 28 and/or APIs 63), text messages, automated voice messages, Facebook messages or Tweets (e.g., via the social network 62 and API data 28 and/or APIs 63), notifications via designated interface or application (e.g., via an API 63 or code 64), and/or the like. As will be recognized, the receiver/recipient may be notified of the funds transfer in a variety of ways to adapt to various needs and circumstances.

In one embodiment, after receiving an appropriate notification, a receiver/recipient (e.g., operating a receiver/recipient computing entity 71-73) can provide receiver/recipient data 24 to the account-to-account server 21 and accept the transfer of funds (e.g., good funds)—Block 830 of FIG. 8. The receiver/recipient data 24 may include information about the receiver/recipient, such as financial instrument data 26 that identifies one or more credit card, debit card, bank, financial accounts through which funds can be received from the sender. That is, the financial instrument data 26 can be used to receive funds from senders. As with senders, a variety of financial instruments can be used by receivers/recipients to receive funds. Continuing with the above example, the receiver/recipient can receive the funds into a debit card (e.g., the account associated with the debit card). After the receiver/recipient (e.g., operating a receiver/recipient computing entity 71-73) accepts the funds transfer and provides appropriate financial instrument data 26, the account-to-account server 21 can initiate transfer of the specified funds from the escrow account to the designated account of the receiver/recipient—Block 835 of FIG. 8. In the example of the sender and receiver/recipient using debit cards, the account-to-account server 21 (e.g., via the escrow logic 25 and API data 28 and/or APIs 63) can initiate transfer of the specified funds to from the escrow account to the debit card account designated by the receiver/recipient. In this example, the transfer of good funds can be carried about by the appropriate EFT payment network/system 51-53—as opposed to submitting the transfer for eventual processing and transfer of funds through an ACH that may take 24-48 to complete the transaction.

In one embodiment, after the transfer of funds is complete, the account-to-account server 21 can provide a notification to the receiver/recipient and/or sender that the transfer of funds is complete (Block 840 of FIG. 8). Such notifications may take many forms, such as email messages (e.g., via the email network 61), text messages, automated voice messages, Facebook messages or Tweets (e.g., via the social network 62), notifications via designated interface or application (e.g., via API data 26 and/or APIs 63), and/or the like. As will be recognized, a variety of approaches and techniques can be used to provide the appropriate notifications.

As will be recognized, such concepts can be used by senders to transfer funds in a variety of contexts. Such contexts may include initiating online transactions, sending money to another person, paying bills, paying for ecommerce purchases, paying merchants or retailers at points of sale (whether online or in person), and/or the like. Further, the account-to-account server 21 (in communication with various entities, systems, and networks) via the API data 28 allows linkage with external wallets, web applications, and third party code 64. This may allow for bi-directional interactions that provide external electronic wallets with the ability to either send or receive account-to-account transactions or the account-to-account transfer function to appear as a financial instrument in a third party electronic wallet, such as during a checkout process at an ecommerce website. For example, this may include providing a branded “account-to-account” payment method directly on an ecommerce web site.

In one embodiment, the account-to-account server 21 can also store transaction data from all senders 41 —43 and/or receivers/recipients 71-73. That is, the account-to-account server 21 (in communication with various entities, systems, and networks) can maintain records of all financial transactions processed through the account-to-account server 21. This may enable the account-to-account server 21 to provide reports regarding transactions and/or provide for the transfer of funds to and from various accounts. As will be recognized, a variety of other approaches and techniques can be used to adapt to various needs and circumstances.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for transferring funds, the method comprising:
receiving, via one or more processors, a request to transfer good funds from a sender account to a receiver, the request to transfer good funds (a) originating from a user of the sender account, (b) identifying at least a portion of debit card number associated with the sender account, (c) identifying the receiver, (d) identifying an amount of good funds to transfer, and (d) to occur in real time through a payment network;
authenticating, via the one or more processors, the request to transfer good funds from the sender account by receiving one or more authentication inputs from the user of the sender account; and
responsive to authenticating the request to transfer good funds from the sender account, initiating, via the one or more processors, the transfer of good funds from the sender account through the payment network, wherein the good funds are transmitted in real time through the payment network responsive to the initiation.

2. The method of claim 1, wherein the amount of good funds is transferred in real time to an escrow account through the payment network.

3. The method of claim 2 further comprising:
receiving an acceptance of the transfer of good funds from the sender account to the receiver, the acceptance of the transfer of good funds (a) originating from the receiver and (b) identifying at least a portion of an account number of a receiver account to which the funds are to be transferred; and
responsive to receiving the acceptance of the request to transfer good funds from the sender account to the receiver, initiating the transfer of good funds from the escrow account to the receiver account through the payment network, wherein the good funds are transmitted in real time from the escrow account to the receiver account through the payment network responsive to the initiation.

4. The method of claim 1, wherein the one or more authentication inputs are selected from the group consisting of a personal identification number, biometric information, a chip authentication, and a secure identification number.

5. The method of claim 1, wherein the good funds are transmitted to a receiver account in real time through the payment network.

6. The method of claim 1, wherein the payment network is an electronic funds transfer network.

7. An apparatus comprising at least one processor and at least one memory including computer program code, the at least one memory and the computer program code configured to, with the processor, cause the apparatus to at least:
receive a request to transfer good funds from a sender account to a receiver, the request to transfer funds (a) originating from a user of the sender account, (b) identifying at least a portion of debit card number associated with the sender account, (c) identifying the receiver, (d) identifying an amount of good funds to transfer, and (d) to occur in real time through a payment network;
authenticate the request to transfer good funds from the sender account by receiving one or more authentication inputs from the user of the sender account; and
responsive to authenticating the request to transfer good funds from the sender account, initiate the transfer of good funds from the sender account through the payment network, wherein the good funds are transmitted in real time through the payment network responsive to the initiation.

8. The apparatus of claim 7, wherein the amount of good funds is transferred in real time to an escrow account through the payment network.

9. The apparatus of claim 8, wherein the memory and computer program code are further configured to, with the processor, cause the apparatus to:
receive an acceptance of the transfer of good funds from the sender account to the receiver, the acceptance of the transfer of good funds (a) originating from the receiver and (b) identifying at least a portion of an account number of a receiver account to which the funds are to be transferred; and
responsive to receiving the acceptance of the request to transfer good funds from the sender account to the receiver, initiate the transfer of good funds from the escrow account to the receiver account through the payment network, wherein the good funds are transmitted in real time from the escrow account to the receiver account through the payment network responsive to the initiation.

10. The apparatus of claim 7, wherein the one or more authentication inputs are selected from the group consisting of a personal identification number, biometric information, a chip authentication, and a secure identification number.

11. The apparatus of claim 7, wherein the good funds are transmitted to a receiver account in real time through the payment network.

12. The apparatus of claim 7, wherein the payment network is an electronic funds transfer network.

13. A computer program product for transferring funds, the computer program product comprising at least one non-transitory computer-readable storage medium having computer-readable program code portions stored therein, the computer-readable program code portions comprising:
an executable portion configured to receive a request to transfer good funds from a sender account to a receiver, the request to transfer good funds (a) originating from a user of the sender account, (b) identifying at least a portion of debit card number associated with the sender account, (c) identifying the receiver, (d) identifying an amount of good funds to transfer, and (d) to occur in real time through a payment network;
an executable portion configured to authenticate the request to transfer good funds from the sender account by receiving one or more authentication inputs from the user of the sender account; and
an executable portion configured to, responsive to authenticating the request to transfer good funds from the sender account, initiate the transfer of good funds from the sender account through the payment network, wherein the good funds are transmitted in real time through the payment network responsive to the initiation.

14. The computer program product of claim 13, wherein the amount of good funds is transferred in real time to an escrow account through the payment network.

15. The computer program product of claim 14 further comprising:
an executable portion configured to receive an acceptance of the transfer of good funds from the sender account to the receiver, the acceptance of the transfer of good funds (a) originating from the receiver and (b) identifying at least a portion of an account number of a receiver account to which the funds are to be transferred; and
an executable portion configured to responsive to receiving the acceptance of the request to transfer good funds from the sender account to the receiver, initiate the transfer of good funds from the escrow account to the receiver account through the payment network, wherein the good funds are transmitted in real time from the escrow account to the receiver account through the payment network responsive to the initiation.

16. The computer program product of claim 13, wherein the one or more authentication inputs are selected from the group consisting of a personal identification number, biometric information, a chip authentication, and a secure identification number.

17. The computer program product of claim 13, wherein the good funds are transmitted to a receiver account in real time through the payment network.

18. The computer program product of claim 13, wherein the payment network is an electronic funds transfer network.
